(19) United States
(12) Patent Application Publication
(10) Pub. No.: US 2006/0136690 A1
(43) Pub. Date: Jun. 22, 2006

(54) Storage device having independent storage areas and password protection method thereof

(75) Inventor: Hsiang-An Hsieh, Sindian City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 11/041,966

(22) Filed: Jan. 26, 2005

(30) Foreign Application Priority Data
Dec. 17, 2004 (TW) 93139528

(51) Int. Cl. G06F 12/14

(52) U.S. Cl. 711/164

(57) ABSTRACT

A storage device having independent storage areas and password protection method thereof are described for resolving the problem of a prior-art storage device assigning its storage memory to a single continuous storage area and its data protection. The multi-sector storage device has a password protection function with an application system being electrically coupled to a control unit through a system end interface. The control unit is electrically coupled to a storage medium through a storage medium interface, and the total storage space of the storage medium includes a plurality of independent storage areas and a dedicated specific area. Several special instruction sets and control methods are built into the control unit, and the objective of the invention is to divide the storage space of the storage device into several independent areas as to enhance the protection of the stored data.

### BACKGROUND OF THE INVENTION

1. Field of the Invention

The present invention relates to a storage device having independent storage areas and a password protection method thereof, and more particularly to a design and a concept for reorganizing the total storage area of a storage medium for protecting the stored data.

2. Description of Related Art

As light, thin, short and compact high-capacity storage devices including a detachable storage medium such as, for example, a zip disk, an optical disc and various types of memory cards, or a portable storage device such as, for example, a USB interface flash memory and an external hard disk drive, are extensively used by users and sold on the market, the storage devices other than the external hard disk drive are designed as devices with a single continuous storage space (as the storage device shown in the right-hand side of FIG. 1) to provide data addresses for a system user to manage data in a convenient and effective way. In other words, a specific storage space is assigned memory addresses and divided into several smaller storage areas, which are provided for the application systems as well as the users to store digital data through a system interface. A single continuous storage area is divided into several specific address areas by means of a specific data structure. For example, a partition table 143 stored in a prior-art master boot record is the start address 142 of a storage device, which describes the data structure including the attributes, start address and length of each sector by a specific data structure. Therefore, the single storage area 4 is divided into a first partition sector 144, a second partition sector 145, a third partition sector 146 . . . to an n^{th} partition sector 147. Further, the aforementioned partition table 143 is combined with a dedicated program of the application system to hide the specific partition sectors. The dedicated program sets and saves a password in order to protect the partition sectors. However, the foregoing function totally depends on the dedicated program to change the attributes of the partition table 243.

Although the aforementioned prior art also can achieve the objectives of dividing the storage area and protecting a specific storage area, its practical applications still have the following shortcomings:

1. The partition table 143 is divided into several partition sections (such as the first partition sector 144, second partition sector 145, third partition sector 146, etc.) by a data structure. Even though all partition sectors of the stored data are divided, the addresses of these partition sectors are still arranged in continuous addresses. In other words, a user can update data through the application system, and thus such arrangement cannot protect the data with different application purposes by dividing the storage area into several areas.

2. The dedicated program changes the data structure of the important partition table frequently to cope with the user's operations, thus causing an extremely high potential risk to the security and stability of the stored data.

Therefore, the prior art usually uses a developing system to divide a single storage of continuous sectors and an application system as a measure for setting the hidden attribute of the data. However, such an arrangement cannot achieve the function of fully and safely protecting the data, since all data stored in the partition sectors, which are set to an isolated protection, still can be accessed through a standard access interface. The dedicated program constitutes an indexed data structure such as changing the attribute of the partition table to “hidden” or moving it to other location to prevent a general application program from accessing the data of each partition sector through the standard file system. However, the data stored in each partition sector still can be accessed by a standard interface, and a user can look up the desired information from the storage device by using an appropriate tool or software. The user's rights will be affected greatly if the confidential information (such as an application program or a confidential document or program) stored in the foregoing storage medium is altered or deleted by accident due to the aforementioned poor security.

### SUMMARY OF THE INVENTION

Therefore, it is a primary objective of the present invention to solve the problem of the prior-art storage device that has no design for assigning the storage space of a storage device into certain partition sectors with different attributes, which requires a user at the application system end to take remedial actions at a later date to protect the stored data.

To achieve the foregoing objective, the present invention provides a storage device having independent storage areas, where its internal components include at least one storage medium, a storage medium interface electrically connected to the storage medium, a system end interface coupled to an external application system, and a control unit electrically connected to the storage medium interface and the system end interface. The storage device with independent storage areas is characterized by the total storage space of the storage medium being divided into a plurality of independent storage areas with different attributes, with independent continuous overlapped fixed addresses set among these independent storage areas. Each independent storage area corresponds respectively to the same area address and partition table.

The present invention provides a password protection method for a storage device having independent storage areas, comprising steps described as follows.

The application system obtains the corresponding information stored in each independent storage area through its built-in control unit when an external application system starts connecting the foregoing storage device of the present invention. If a user intends to access a non-preinstalled independent storage area, then a dedicated special instruction set built in the control unit starts the non-preinstalled independent storage area.

Whether or not the non-preinstalled independent storage area sets a protection password is determined. If a password is set, then the input value of password is checked. If the input password is incorrect, then the access instruction output from the application system is redirected to the independent storage area, which stores confidential information or directly prohibits users from accessing the data stored in such an independent storage area.

The application system accesses the data stored in the non-preinstalled independent storage area. If the foregoing independent storage area does not have a password for the protection or the input password is correct, then the application system can access the data stored in the non-preinstalled independent storage area while all independent areas other than the opened one will enter into a suspend mode immediately and the data in these independent storage areas cannot be accessed.

In summary, the present invention divides the storage space of a storage device into several independent areas to further enhance the protection function of the stored data.

To make it easier for our examiner to further understand the features and technical contents of the present invention, Reference is made to the detailed description and drawings of the present invention. However, the drawings are provided for the purpose of reference and description only, and are not to be construed as limitations on the scope of the present invention.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view of the structure of a prior-art single continuous storage area;

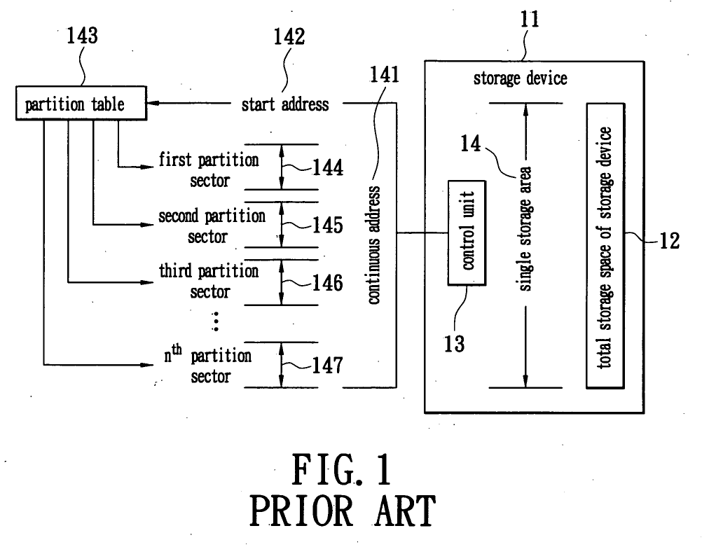

FIG. 2 is a functional block diagram of a storage device having independent storage areas according to the present invention;

FIG. 3 is a schematic view of the structure of a storage device having independent storage areas according to the present invention;

FIG. 4 is a flow chart of the password protection method for the storage device having independent storage areas according to the present invention; and

FIG. 5 is another flow chart of the password protection method for the storage device having independent storage areas according to the present invention.

### DETAILED DESCRIPTION OF THE PREFERRED EMBODIMENTS

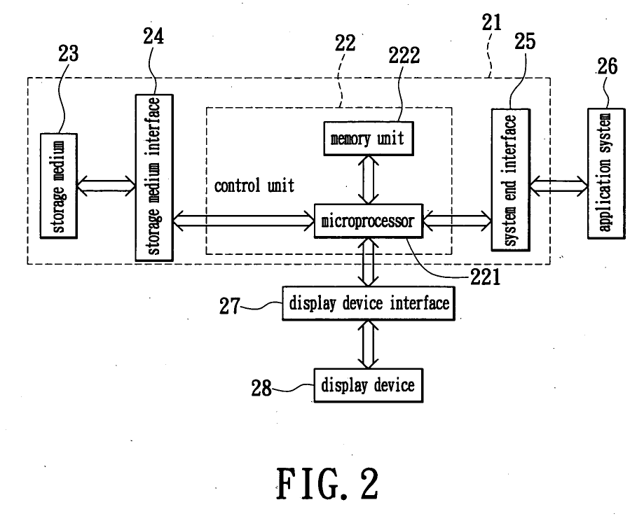

Reference is made to FIG. 2 for the multi-sector storage device 21 having a password according to the present invention. The internal components include a storage device 23, a storage medium interface 24 electrically coupled to the storage medium 23, a system end interface 25 coupled to an external application system 26, and a control unit 22 electrically coupled to the storage medium interface 24 and the system end interface 25. The control unit 22 comprises a microprocessor 221 for computing and controlling digital signals and a memory unit 222 for storing a control program, characterized by the operation flow installed in the control unit 22 having the function of dividing the total storage space of the storage medium 23 into several independent storage areas, and these independent storage areas having independent continuous overlapped fixed addresses. In other words, the start address of each independent storage area is the same fixed storage address (which is generally 0), but the data stored in each independent storage area may have different attributes.

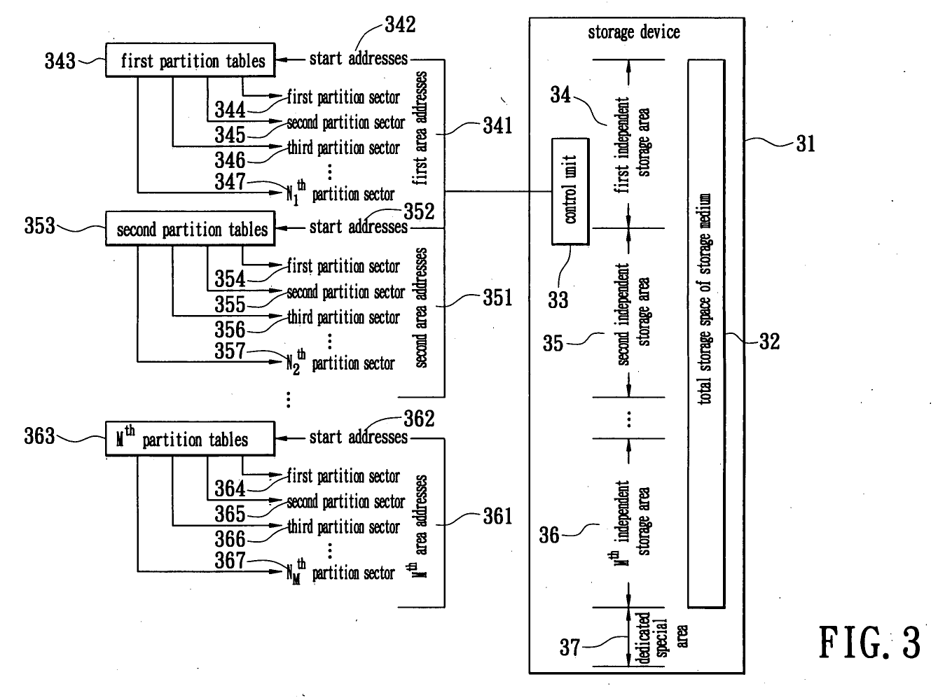

With reference to FIG. 3, the control unit 33 divides the total storage space 32 into M-1 independent storage areas including a first storage area 34 and a second storage area 35, and so on, and a M^{th} special hidden area 36 and a dedicated special area 37 for recording passwords. The first independent storage area 34 is provided for users to record digital information. A second independent storage area 35 is provided for special application manufacturers (such as a smart phone manufacturer) to store a dedicated application program, and set a password for protection to prevent users from deleting or damaging the dedicated application program and data by mistakes. A special hidden independent area 36 is provided to replace the storage area of setting a password protection and setting a read only attribute to protect the information and application program stored therein. A password recording area 37 is provided for storing a user-defined password to check whether the storage area has enabled a password protection function.

Each independent storage area 34, 35, 36 corresponds to the same area address 341, 351, 361 and partition table 343, 353, 363, respectively. As to the application program, each independent storage area acts as a detachable storage device installed in each independent storage medium, which is similar to several different disks being inserted into the same floppy disk drive. However, the present invention assigns and differentiates a single set of storage medium by a control process implemented in a controller to achieve similar effects. In practical applications, special instructions are used to enable an area through software, which is different from physically ejecting a floppy disk from the floppy disk drive or changing floppy disks. Every independent storage area still adopts the booting sector to set the partition table for dividing the storage area into several sectors according to the prior art.

In the early stage of the design, the foregoing storage area of the storage device enables a start area (such as the first independent storage area 34) and sets the rest of the storage areas (such as the second independent area 35 and a special hidden independent area 35) to a suspend mode, such that a user cannot access an unopened area.

In summary, the present invention can prevent users from accessing data through a system application by means of the division into independent areas and opening only one independent storage area at a time, and also can prevent users from modifying a confidential document or program to assure the security of the confidential data.

With reference to FIG. 2, a display device 28 is provided for displaying the data stored in the multi-sector storage device 21 having a password protection and its operating status. A display device interface 27 electrically is coupled to a control unit 22 and a display device 28 acts as a contact and communication tool between the control unit 22 and the display device 28. In practical applications, the storage medium 23 multi-sector storage device 21 having a password protection function can comprise one or more storage memory chips, and the storage medium 23 can be a volatile memory chip or a non-volatile memory chip.

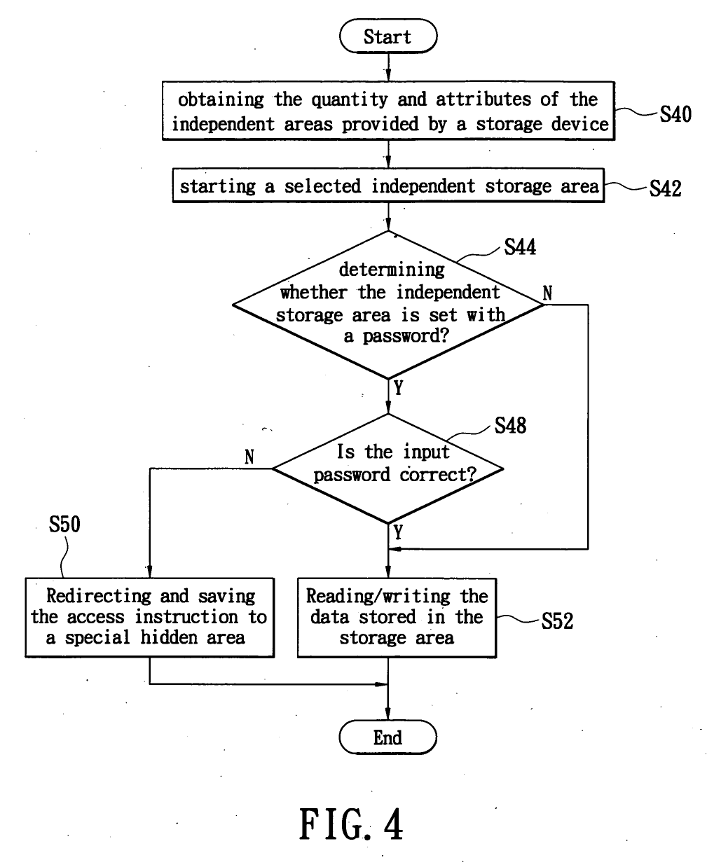

With reference to FIG. 4, in Step S40, if a user connects a storage device of the present invention through an application system, the application system will obtain several storage medium quantities (actually obtaining the independent storage areas produced by several partition tables) and the corresponding attributes in accordance with the design of the present invention. For example, the storage devices as shown in FIG. 3 will obtain M-1 independent storage areas for users to access data. Since the second independent storage area 33 is provided for storing a dedicated application program and setting a password for protection, therefore the independent storage area 33 becomes an inaccessible data block.

If a user intends to access a non-preset independent areas (such as the foregoing second storage area 33), then the built-in dedicated special instruction set enables other storage areas through the control unit 33, and this procedure comprises the steps of:

Step S42: starting the independent storage area selected by users;

Step S44: determining whether or the independent storage is password protected;

Step S52: a user freely accessing data from the independent storage area, if no password is set;

Step S48: examining the input value of a password, if a password is set, and an examination method is provided to compare the input password with the password stored in the dedicated special area 37;

Step S52: a user freely accessing data from the independent storage area, if the input password is correct; and Step S50: redirecting the access instruction to a read-only special hidden area 36 to define a confidential statement and description stored in the special hidden area 36, or, if the input password is incorrect, setting the storage areas other than the opened independent storage areas into a suspend mode, thus making these storage areas inaccessible.

Further, a user can set a password to protect the information stored in each independent storage area, and the control unit sets a dedicated special area to record the attributes of each independent storage area well as its password.

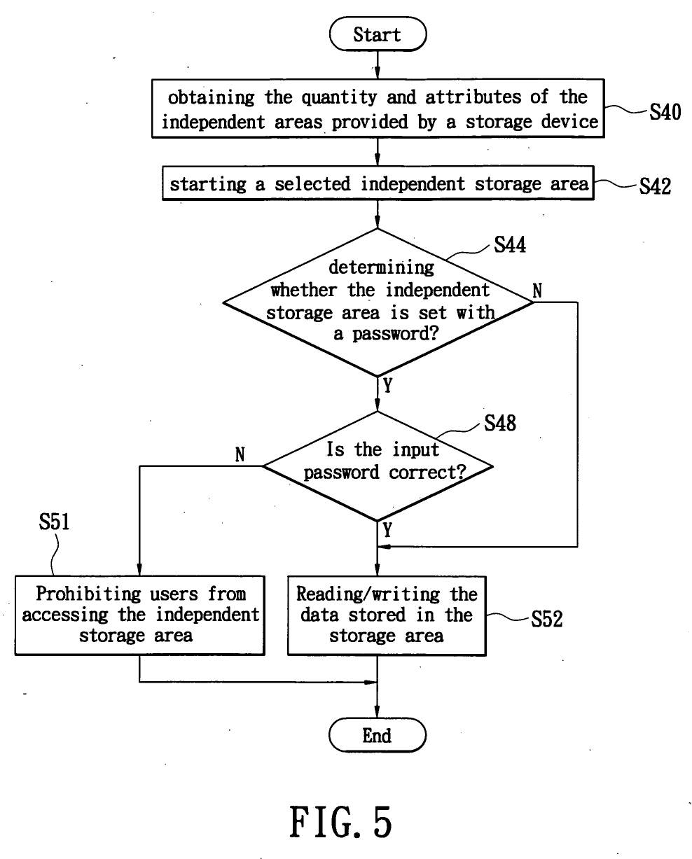

With reference to FIG. 5, Step S50 illustrated in FIG. 4 is replaced by Step S51: if the comparison test indicates an incorrect password, then the user is prohibited from accessing the independent storage area.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A storage device having independent storage areas, and its internal components comprising:
at least one storage medium;
a storage medium interface electrically coupled to said storage medium;
a system end interface coupled to an external application system; and
a control unit electrically coupled to said storage medium interface and said system end interface;
wherein the storage device having independent storage areas is characterized by a total memory space of said storage device being assigned to a plurality of independent storage areas with different attributes, and said each independent storage area having an independent continuous overlapped fixed address, wherein said each independent storage area corresponds to a same area address and partition table.

2. The storage device having independent storage areas of claim 1, wherein one of said storage areas is preset as a start area, and other said storage areas are set to a suspend mode.

3. The storage device having independent storage areas of claim 1, wherein said independent storage areas include an attribute selected from a collection of having a password, having no password, hidden attribute, read only attribute and not accessible attribute.

4. The storage device having independent storage areas of claim 1, further comprising:
a display device, for displaying the data stored in said storage device and an operation status; and
a display device interface, being electrically coupled to said control unit for establishing contact and communication between said control unit and said display device.

5. The storage device having independent storage areas of claim 1, wherein a password protection is used, said method comprising the steps of:
an application system obtaining corresponding information stored in said each independent storage area through said control unit, when an external application system starts connecting said storage device, wherein if a user intends to access a non-preinstalled independent storage area, then a dedicated special instruction set built into said control unit starts said non-preinstalled independent storage area;
determining whether or not said non-preinstalled independent storage area sets a protection password;
if a password is set for protection, then checking an input value of said password;
if a password check indicates an incorrect result, then transferring an access instruction output from said application system to said independent storage area storing confidential information or prohibiting users from accessing data stored in said independent storage area; and
said application system accessing the data stored in said non-preinstalled independent storage area, wherein if said independent storage area has no password protection or the password check indicates a correct result, then all independent areas other than an opened one enter into a suspend mode immediately and data in said independent areas is inaccessible.

6. The password protection method of claim 5, wherein said independent storage area includes information of quantity and corresponding attributes.

7. The password protection method of claim 6, wherein said application system obtains said information of quantity from said control unit according to said independent storage area produced by a plurality of partition tables.

8. The password protection method of claim 5, wherein said storage medium includes a dedicated special area for recording an attribute of said each independent storage area and a password.

9. The password protection method of claim 8, wherein said control unit adopts a password check according to a result of a comparison test on a password stored in said dedicated special area.

10. The password protection method of claim 5, wherein said application system obtains said information of attribute from said control unit according to a record of said dedicated special area.

11. The password protection method of claim 5, wherein said each independent storage area comprises a password set by a user for protecting information recorded therein.
